(19) United States
(12) Patent Application Publication
(10) Pub. No.: US 2009/0327726 A1
(43) Pub. Date: Dec. 31, 2009

(54) INFORMATION RECORDING/REPRODUCTION APPARATUS AND SYSTEM

(75) Inventors: Nobuaki Suzuki, Ome-shi (JP); Kunio Honsawa, Ome-shi (JP); Kazuaki Iwamura, Ome-shi (JP); Chikara Ushimaru, Hamura-shi (JP); Yoshihisa Kizuka, Ome-shi (JP); Hiroshi Kazawa, Ome-shi (JP); Yoshinobu Fujiwara, Ome-shi (JP); Tatsuyuki Matsushita, Tokyo (JP); Takeshi Daiku, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/491,870

(22) Filed: Jun. 25, 2009

(30) Foreign Application Priority Data
Jun. 25, 2008 (JP) 2008-166159

(51) Int. Cl. H04L 9/32; H04N 7/167; H04L 9/06

(52) U.S. Cl. 713/169; 380/200; 380/44

(57) ABSTRACT

According to one embodiment, a data transmission control section ends transmission of a title without copyright protection at time t2. When transmission time of the title exceeds prescribed time, interruption of the transmission is posted to a reception-side device, and a key discard/creation section creates a new encryption key. A copyright-protected title is transmitted to the reception-side device by using the new key.

### CROSS-REFERENCE TO RELATED APPLICATIONS

This application is based upon and claims the benefit of priority from Japanese Patent Application No. 2008-166159, filed Jun. 25, 2008, the entire contents of which are incorporated herein by reference.

### BACKGROUND

1. Field

One embodiment of the present invention relates to an information recording/reproduction apparatus and a system which transmit copyright-protected titles via a network.

2. Description of the Related Art

In recent years, devices, which transmit copyright-protected titles via a network such as LAN for home using an encryption technique such as Digital Transmission Content Protection (DTCP), are starting to spread. In DTCP, devices have respective IDs and mutually authenticate using public key encryption or common key encryption, and authenticate a protecting ability of contents each other. Only after that, they can carry out recording/reproduction or transmission. When the authentication is competed, a transmission-side device creates an encryption key, and a reception-side recorder creates a decoding key, so that video data or the like are encrypted in order to be transmitted.

In the DTCP standards as Move processing standards of copyright-protected titles, when prescribed time (two hours) passes with the encryption key unused, namely, when no encryption process is executed continuously for two hours, the old key is discarded and a new key should be created. When a key is requested to be authenticated or exchanged by an encryption data receiving apparatus at timing just before two hours as the prescribed time elapses, the old key is transmitted to the encryption data receiving apparatus. However, since encryption data transmitted after that is encrypted by a newly created key, the receiving apparatus cannot decode that encryption data. In order to solve this problem, Jpn. Pat. Appln. KOKAI Publication No. 2007-104430 (FIG. 6) discloses the following technique. With this technique, when the encryption data receiving apparatus requests new authentication or exchange of a new key just before two hours as the prescribed time elapses after the transmission of the encryption data, a key updating process is executed so that data encrypted by a newly created key is transmitted to the receiving apparatus.

In a conventional system, when a plurality of titles including copyright-protected title (video data) and a title without copyright protection are tried to be transmitted as one title, a problem occasionally arises. That is, after the copyright-protected title to be encrypted is transmitted, the title without copyright protection which is not encrypted is transmitted for not less than two hours and the copyright-protected title to be encrypted is transmitted continuously thereafter. At this time, since the copyright-protected title to be transmitted later cannot use the key used before, and thus this title cannot be encrypted.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating a constitution of a transmission-side device 10 according to one embodiment of the present invention;

FIG. 2 is a block diagram illustrating a constitution of a reception-side device 20 according to one embodiment of the present invention;

FIG. 3 is a diagram illustrating an outline of the above embodiment;

FIG. 4 is a flowchart illustrating an operation of the transmission-side device 10; and

FIG. 5 is a flowchart illustrating an operation of the transmission-side device 10.

### DETAILED DESCRIPTION

Various embodiments according to the invention will be described hereinafter. In general, according to one embodiment of the invention, there is provided an information recording/reproduction apparatus which transmits mixed titles including copyright-protected titles which are protected by copyright and titles without copyright protection which are not protected by copyright to a reception-side device via a network, comprising:

creation means for communicating with and mutually authenticating the reception-side device in order to create encryption keys; encryption means for encrypting the copyright-protected titles using the encryption keys created by the creation means; and transmission control means for transmitting the titles without copyright protection and the encrypted copyright-protected titles to the reception-side device,

wherein when a plurality of titles composed by arranging a title without copyright protection between first and second copyright-protected titles are transmitted and transmission of the title without copyright protection exceeds prescribed time, the transmission control means posts interruption of the transmission to the reception-side device, and creates a new encryption key using the creation means in order to transmit the second copyright-protected title to the reception-side device.

A system is realized in which, even when the title without copyright protection which is not encrypted is transmitted over the key-discard prescribed time after the copyright-protected title is transmitted, the copyright-protected title to be encrypted can be transmitted thereafter.

An embodiment of the present invention will be described below with reference to the drawings.

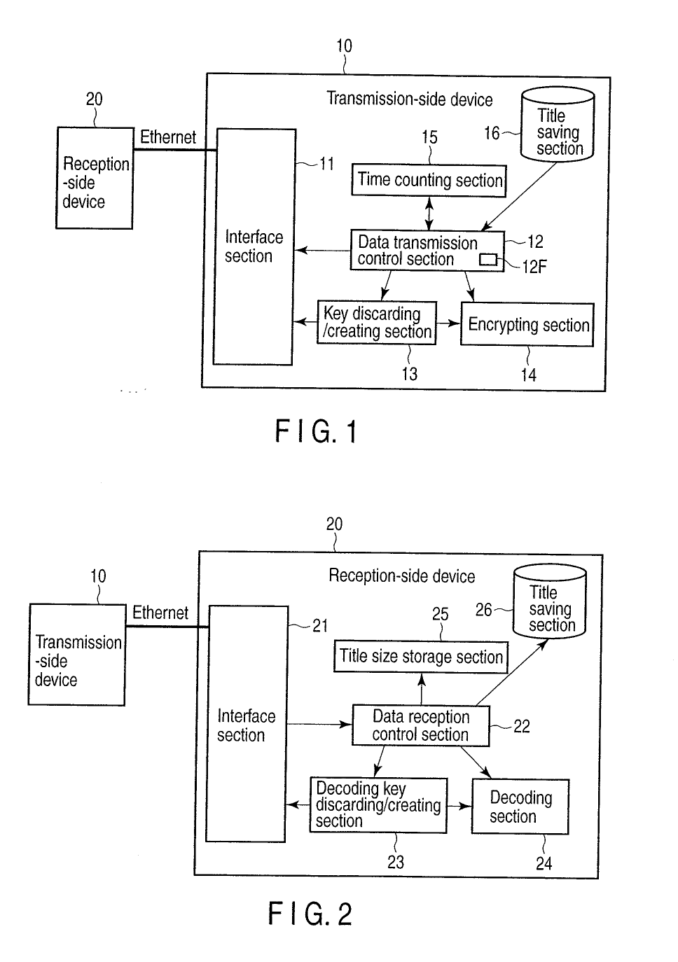

FIG. 1 is a block diagram illustrating a constitution of a transmission-side device 10 according to one embodiment of the present invention. FIG. 2 is a block diagram illustrating a constitution of a reception-side device 20 according to one embodiment of the present invention. The transmission-side device 10 and the reception-side device 20 are information recording/reproduction apparatuses such as personal computers connected by a network such as LAN for home, DVD recorders or set-top box (STB). They are compatible with DTCP. FIG. 1 is the diagram illustrating an extracted constitutional portion relating to a title transmitting function in the information recording/reproduction apparatus. FIG. 2 is the diagram illustrating an extracted constitutional portion relating to a title receiving function in the information recording/reproduction apparatus.

The transmission-side device 10 will be described. As shown in FIG. 1, the transmission-side device 10 includes an interface section 11, a data transmission control section 12, a key discard/creation section 13, an encryption section 14, a time counting section 15 and a title saving section 16.

The interface section 11 communicates with the reception-side device 20 via a network using Ethernet (registered trademark). The key discard/creation section 13 carries out mutual authentication via the communication with the reception-side device 20 in order to create an encryption key, for example. The encryption section 14 encrypts a title saved in the title saving section 16 using the encryption key created by the key discard/creation section 13. The data transmission control section 12 transmits the title read from the title saving section 16 or the title encrypted by the encryption section 14 to the reception-side device 20. The time counting section 15 provides time information to the transmission control section 12 at the time of transmitting titles.

The reception-side device 20 will be described next. As shown in FIG. 2, the reception-side device 20 includes an interface section 21, a data reception control section 22, a decoding key discard/creation section 23, a decoding section 24, a title size storage section 25 and a title saving section 26.

The interface section 21 communicates with the transmission-side device 10 via a network using Ethernet or the like. The decoding key discard/creation section 23 carries out mutual authentication via the communication with the transmission-side device 20 in order to create a decoding key, for example. The decoding section 24 decodes a title using the decoding key created by the decoding key discard/creation section 23. The reception control section 22 receives the title transmitted by the transmission-side device 10 and saves it in the title saving section 26, or decodes the title in the decoding section 24 and saves it in the title saving section 26. The title size storage section 25 stores a total data amount of titles transmitted at the one-time data transmitting process therein.

A transmitting system according to one embodiment of the present invention will be described. In this embodiment, mixed titles including copyright-protected titles protected by copyright and titles without copyright protection are transmitted at the Move process between the devices shown in FIGS. 1 and 2 arranged on the network. The titles are, for example, recorded digital broadcasts. In this embodiment, the titles are saved in the title saving section 16 in advance. The digital broadcasts include both copyright-protected titles and titles without copyright protection. The copyright-protected digital broadcast titles are prohibited from undergoing the copying process but can undergo the Move process. The Move process is a process for deleting transmitted data from the transmission-side device when titles are transmitted from the transmission-side device to the reception-side device.

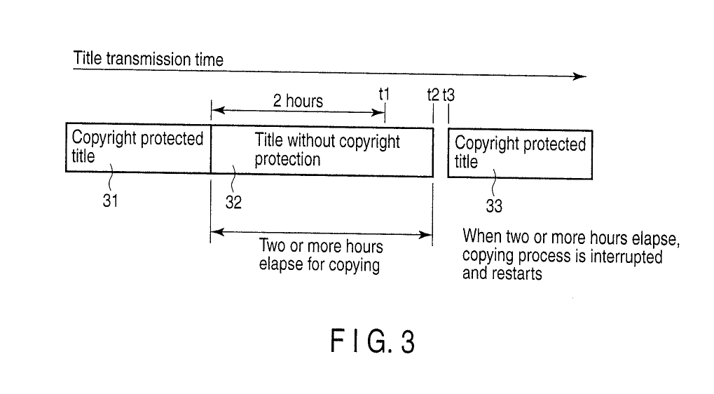

FIG. 3 is a diagram illustrating an outline of this embodiment.

In this example, three titles 31 to 33 specified by a user are transmitted as one title from the transmission-side device 10 to the reception-side device 20 substantially continuously according to the DTCP system. In this example, after the copyright-protected title 31, the title without copyright protection 32 is transmitted for not less than 2 hours, and then the copyright-protected title 33 is transmitted.

The copyright-protected titles 31 and 33 are encrypted by using different encryption keys, and are transmitted to the reception-side device 20. The title without copyright protection 32 is not encrypted and is transmitted to the reception-side device 20. When two hours elapse from the start of the transmission of the title without copyright protection 32 at t1, the key used for encryption of the copyright-protected title 31 is discarded as defined in DTCP. After the transmission of the title without copyright protection 32, when the copyright-protected title 33 is transmitted, the transmission-side device 10 automatically executes an interrupt process at times t2 to t3 in order to create a new key. The transmission-side device 10 encrypts the copyright-protected title 33 using the created key and restarts the Move process in order to transmit the copyright-protected title 33.

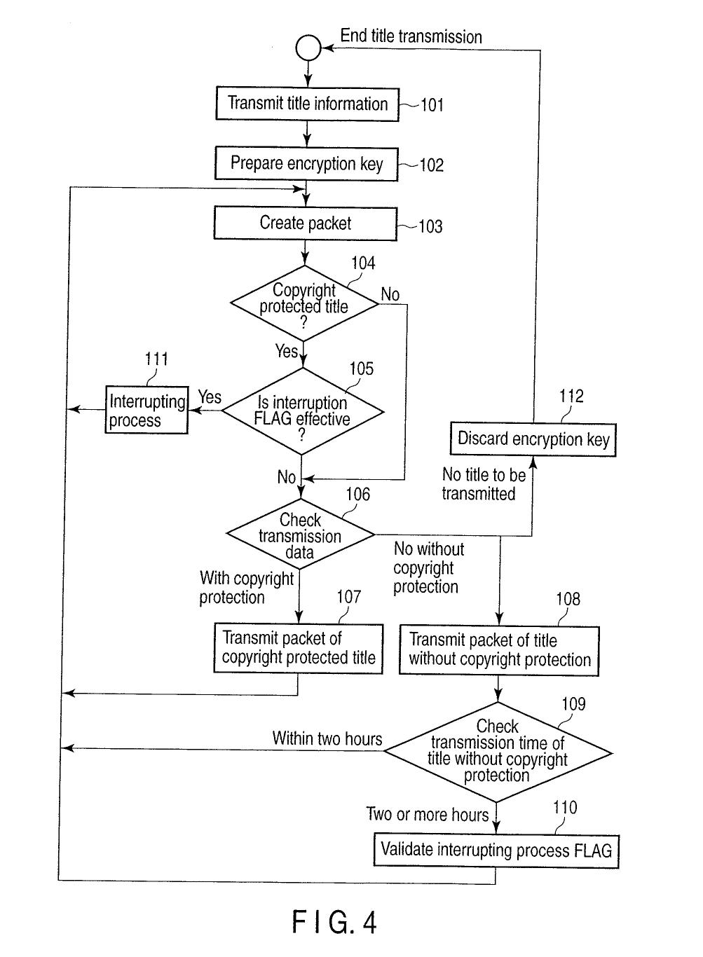

FIG. 4 is a flowchart illustrating an operation of the transmission-side device 10. The case where the titles 31 to 33 are transmitted continuously as shown in FIG. 3 will be described.

The data transmission control section 12 establishes a TCP connection and transmits title information such as a title size to the reception side (101). When the TCP connection is ON, a network connection with the reception-side device is established, so that data communication is enabled. The title size is a size obtained by adding the sizes of the three titles 31 to 33 in the example of FIG. 3. Before transmission of the title main body, the transmission control section 12 communicates with the reception-side device according to procedure defined by DTCP using the key discard/creation section 13 in order to create an encryption key in block 102.

The transmission control section 12 starts to read the title 31 from the title saving section 16, and divides the read title into a unit of the DTCP standards, in order to create a packet (103). At this time, the transmission control section 12 combines a flag indicating presence/absence of copyright protection (in this example, protection present flag) with divided title data in the packet in order to create a packet. As a data transmission system of HTTP POST, “chunk” is used. HTTP POST is a transmission protocol to be used at the time of transmission of titles. When the chunk data transmission system is adopted, a title can be transmitted without posting a title size of the title to the reception-side device in advance. End of the transmission is posted by transmitting “chunk 0” to the reception-side device. A reason for adapting the chunk system regardless of posting the title size in block 101 will be described later.

The transmission control section 12 checks whether the created packet is for the copyright-protected title in block 104. When the packet is for the copyright-protected title, the transmission control section 12 determines whether an interrupt flag, mentioned later, is set in block 105. If the interrupt flag is not set (No at 105), the flow goes to block 106.

The transmission control section 12 checks transmission data in block 106. That is, the transmission control section 12 checks whether each packet is a packet for a copyright-protected title, a packet for a title without copyright protection or end of transmission. When the packet is a packet for copyright-protected title, the transmission control section 12 encrypts the packet using the key created in block 102 in order to transmit it to the reception-side device 20 in block 107. The transmission control section 12 repeats blocks 103 to 107 and transmits the copyright-protected title 31 to the reception-side device 20.

When the transmission of the copyright-protected title 31 is completed, the transmission control section 12 starts to create and transmit a packet of the title without copyright protection 32. At this time, flow moves to block 108 via blocks 103 to 106. The transmission control section 12 does not encrypt the packet of the title without copyright protection 32 and transmits it directly to the reception-side device 20 in block 108.

When the title without copyright protection is transmitted, the transmission control section 12 counts transmission time of the title without copyright protection using the time counting section 15, and checks whether the title transmission time exceeds two hours (109). When the transmission time for the title without copyright protection exceeds two hours, the key is discarded. For this reason, the next copyright-protected title 33 cannot be encrypted. For this reason, the transmission control section 12 sets the interrupt flag 12F (FIG. 1) in block 110. The timing of block 110 corresponds to time t1 in FIG. 3.

When the transmission of the title without copyright protection 32 is completed, the transmission control section 12 starts to create and transmit a packet of the copyright-protected title 33. When the copyright-protected title is transmitted, the transmission control section 12 checks whether the interrupt flag is set in block 105. If the interrupt flag is set (Yes at 105), elapse time of unused encryption key exceeds two hours. Therefore, since the copyright-protected title cannot be encrypted, the interrupt process of the Move process is executed (111). At this interrupt process, the transmission control section 12 transmits “chunk 0” to the reception-side device 20 in order to post interruption of the title transmitting process. The key discard/creation section 13 discards a current key, communicates with the reception-side device 20 in order to create a new encryption key and clears the interrupt flag. The timing of the interrupt process corresponds to time t2 to t3 in FIG. 3. During the interrupt process, the TCP connection is maintained. After the interrupt process, the encryption section 14 encrypts the packet using the newly created encryption key, and the data transmitting section 12 transits the encrypted packet to the transmission-side device 20 (107). The transmission control section 12 repeats blocks 103 to 107 and transmits the copyright-protected title 33 to the reception-side device 20.

When the transmission of the copyright-protected title 33 is completed, the key discard/creation section 13 discards the encryption key (112). At this time, the transmission control section 12 terminates the TCP connection in order to end the transmission. Because of the Move process, the transmission control section 12 deletes the transmitted title from the title saving section 16 at the time of the end of the transmission.

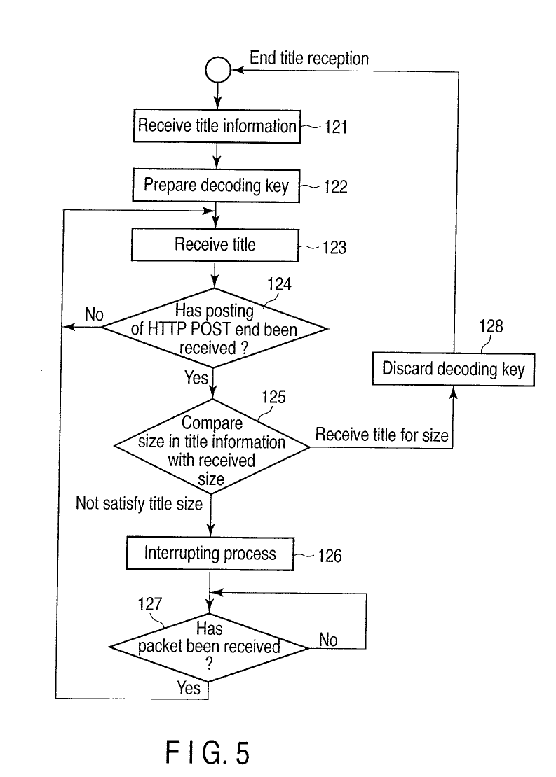

An operation of the reception-side device 20 will be described below. FIG. 5 is a flowchart illustrating the operation of the reception-side device 20.

The reception control section 22 receives information about titles to be received (title total size or the like) from the transmission-side device 10 in block 121, and stores the title total size in the title size storage section 25. The reception control section 22 communicates with the transmission side, and creates a decoding key for decoding the encrypted title transmitted from the transmission side using the decoding key discard/creation section 23 (122).

The reception control section 22 receives a packet of titles including information about the copyright protection presence/absence created on the transmission side in block 23. The reception control section 22 allows the decoding section 24 to decode titles using the created keys by a packet unit, in order to save the titles in the title saving section 26. As the data transmission system of HTTP POST, chunk is used. The reception control section 22 checks the reception of posting the HTTPS POST end (chunk 0) (124). When the posting is not received, the flow goes to block 123, and the reception and the decoding of the titles are continued.

When receiving the posting of the end (chunk 0) (Yes at 124), the reception control section 22 compares the title total size stored in the title size storage section 25 with a file size of the title received and decoded by block 123 (125). When the file size of the received title is larger than the title total size, the flow goes to the interrupt process in block 126. The posting of the end (chunk 0) represents the end of the title transmission, but since the file size of the received title is smaller than the title total size here, the reception control section 22 determines that the title data which should be transmitted to the transmission side is still present.

The reception control section 22 sets a Move validation flag 22F, in order to execute a Move validation process up to the received portion in block 126. The reception control section 22 exchanges with the transmission side, and creates a decoding key using the decoding key discard/creation section 23 in order to wait for reception of a residual title portion in block 127.

When the file size of the received title matches with the title total size in block 126, the reception control section 22 determines that all the titles are received, validates the received titles, and discards the encryption key (128).

According to one embodiment of the present invention, when titles are transmitted according to the DTCP system, even if a title whose encryption key is not used over 2 hours as the prescribed time is present during the transmission, a plurality of titles can be transmitted as one title. The HTTP POST transmission system is chunk, so that the interruption can be enabled during the transmission of titles. When the transmission is continued without disconnecting the TCP session, even if a title is divided by the interrupt process, the reception side can receive divided titles as one title.

In the embodiment, as shown in FIG. 4, the status of the interrupt flag is checked for each packet, but the copyright-protected title 31 or 33 may be transmitted at one time in block 107 (the packet is transmitted continuously), or the title without copyright protection 32 may be transmitted at one time in block 108. In this case, the transmission time can be shortened.

As shown in FIG. 3, the embodiment has described the case where after the copyright-protected title 31, the title without copyright protection 32 is transmitted for over two hours, and then the copyright-protected title 33 is transmitted as an example of the present invention. However, the present invention is not limited to this example, and also in a case where the title without copyright protection 32 is firstly transmitted for over 2 hours, and then the copyright-protected title 33 is transmitted, the present invention is effectively operated. In this case, the operation is similar to that in the embodiment shown in FIGS. 4 and 5, but is different in that an encryption key and an decoding key are created for the first time in the interrupt process after the transmission of the title without copyright protection 32.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording and reproduction apparatus configured to transmit mixed titles comprising copyright-protected titles and titles without copyright protection to a reception-side device via a network, comprising:
a creation module configured to communicate with the reception-side device and to mutually authenticate the reception-side device in order to create encryption keys;
an encryption module configured to encrypt the copyright-protected titles using the encryption keys; and
a transmitter configured to transmit the titles without copyright protection and the encrypted copyright-protected titles to the reception-side device,
wherein the transmitter is configured to post interruption of the transmission to the reception-side device, and to create a new encryption key using the creation module in order to transmit a second copyright-protected title to the reception-side device when a plurality of titles comprising a title without copyright protection between a first and the second copyright-protected titles are transmitted and transmission of the title without copyright protection exceeds a prescribed time.

2. The information recording and reproduction apparatus of claim 1, wherein
the transmitter comprises a posting module configured to post a total file size of the plurality of titles when the transmission of the plurality of titles is started, and a transit module configured to transit an end signal representing end of the transmission to the reception-side device after the title without copyright protection is transmitted, and
the reception-side device is configured to determine that the transmission is interrupted based on a file size of the received files, the total file size and the end signal.

3. The apparatus of claim 2, wherein the encryption of the copyright-protected titles is based on Digital Transmission Content Protection (DTCP) standards.

4. An information recording and reproduction apparatus configured to receive mixed titles comprising copyright-protected titles and titles without copyright protection from a transmission-side device via a network, comprising:
a creation module configured to communicate with the reception-side device and to mutually authenticate the transmission-side device in order to create decoding keys;
a receiver configured to receive the titles without copyright protection and the encrypted copyright-protected titles from the transmission-side device; and
a decoder configured to decode the copyright-protected titles received from the transmission-side device using the decoding keys,
wherein the receiver is configured to create new decoding keys using the creation module and to wait for transmission of the titles from the transmission-side device when the interruption is posted from the transmission-side device.

5. The apparatus of claim 4, wherein the receiver comprises a module configured to receive a total file size of the titles and an end signal representing end of the transmission from the transmission-side device, and to determine that the transmission is interrupted based on a received file size of the titles, the total file size and the end signal.

6. A receiving method for receiving mixed titles comprising copyright-protected titles and titles without copyright protection from a transmission-side device via a network, comprising:
communicating with the transmission-side device;
mutually authenticating the transmission-side device in order to create decoding keys;
decoding the copyright-protected titles received from the transmission-side device using the created decoding keys; and
communicating with and mutually authenticating the transmission-side device in order to create a new decoding key, and waiting for transmission of the title from the transmission-side device when the interruption is posted from the transmission-side device after the title without copyright protection is received.

7. The method of claim 6, further comprising:
receiving an end signal representing end of the transmission, if a file size of a received title is smaller than the total file size; and
determining that the transmission is interrupted, after a total file size of the titles is received from the transmission-side device and the title without copyright protection is received.
